(19) United States
(12) Patent Application Publication
(10) Pub. No.: US 2005/0058080 A1
(43) Pub. Date: Mar. 17, 2005

(54) Methods and apparatus for measuring service disruption

(76) Inventors: Simon John Fiddes, Edinburgh (GB); Nicholas William Gent, Dalkeith (GB); Atanu Nag, Belfast (IE)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/942,106

(22) Filed: Sep. 16, 2004

(30) Foreign Application Priority Data
Sep. 16, 2003 (GB) 03 21 641.3

(51) Int. Cl. H04L 12/26

(52) U.S. Cl. 370/242; 370/252

(57) ABSTRACT

Measurement of duration of service disruption affecting communication of a data stream containing payload data and non-payload symbols interspersed within the payload data is accomplished by monitoring the data stream to detect a symbol having a value indicative of occurrence of an error in the payload data. Upon detection of a symbol having a value indicative of occurrence of an error, monitoring continues for the occurrence of errors in a modified version of the data stream, the modified version comprising the received data stream with the detected symbol omitted. An error is determined to have occurred if another symbol having a value indicative of occurrence of an error is detected in the modified version of the data stream after the omitted symbol. The duration of service disruption is taken as being the elapsed time between commencement of disruption of reception and the last determination of occurrence of an error in the modified version of the data stream.

This invention relates to methods and apparatus for measuring the duration of service disruption affecting communication of a data stream containing payload data and non-payload symbols interspersed within the payload data.

### BACKGROUND ART

Telecommunications networks send large amounts of data, including voice communications, throughout the world. Since the delivery of these data is very important, the traffic channels that transmit the data are frequently backed up with one or more “protection” channels, one of which takes over the transmission of data if a traffic channel fails. When a failure is detected in a channel (for example when a cable is damaged) the data loss or degradation is detected at the receiving end, and a message is sent back to the sending end to switch the transmission of that channel's data to a protection channel.

New equipment must meet defined standards for speed to detect a data loss, switch to the protection channel and re-establish data transmission. In order to ensure that the equipment complies with required criteria, the time taken to re-establish transmission in the event of failure must be measured. Telecommunications test sets are used to test new links before they are made live. Amongst the many tests carried out is a measurement of the time taken to perform a protection switch. This measures the time that the service is disrupted and is termed a “service disruption” test.

Known methods of service disruption measurement include use of a Pseudo-Random Binary Sequence (PRBS) which is sent as a test signal from the sending end. A corresponding PRBS is generated by receiving equipment at the receiving end of the test apparatus, suitably delayed to compensate for signal propagation times, and compared with the incoming signal. When data are being reliably transferred the PRBS generated at the receiving end matches the incoming signal and no mismatches are detected. When a protection switch is induced the delayed PRBS fails to match the incoming signal and a time counter is started. The receiving equipment then continuously seeds its PRBS generator with the incoming (faulty) signal and looks for mismatches between the incoming signal and the delayed PRBS. As long as a mismatch is detected the receiving equipment re-seeds its PRBS generator and the process repeats until the generated sequence again matches the incoming signal. If the resumed match is sustained for a specified “guard band” time (e.g. 200 ms) then the protection switch time is taken as the time from the initial mismatch until the last error was detected.

In order to record accurately the time that the incoming signal becomes fault-free and matching is re-established, the value of the time counter is latched every time the receiving equipment re-seeds its PRBS generator or detects a mismatch. Thus after the required mismatch-free time has elapsed the latch contains the time of the duration of the service disruption. It is desirable to achieve a measurement resolution of much better than 1 millisecond in order to measure PRBS error-bursts, which are typically tens of milliseconds in duration.

Whilst a raw PRBS pattern, which may be regarded as the payload data, can sometimes be sent through a telecommunications network it is often necessary to include frame alignment information in a test signal in order to allow the equipment being tested to function. The signal is divided into frames and each frame comprises a small number of framing and housekeeping bits and a relatively large number of payload data bits. For example, a DS1 (T1) frame contains 192 bits for payload preceded by a framing bit. A superframe (SF) comprises 12 DS1 frames, and an extended superframe (ESF) contains 24 DS1 frames.

This introduces a problem into the service disruption measurement in that when the test signal is once again received by the receiving end after a disruption the framing synchronisation will have been lost, so it will not be known which bits are payload data bits and which are framing/housekeeping bits. If a non-payload data bit (such as a housekeeping or framing bit) is inadvertently taken as a PRBS payload data bit, a PRBS mismatch will occur and the receiving equipment will not accurately detect when the incoming signal has been restored. Thus a framing algorithm has been required to find and remove the framing/housekeeping bits after the error-burst has finished. Prior art methods and apparatus have provided several ways to effect framing of the incoming signal.

For ITU E1-E4 rates the framing sequence is a group of 8 to 12 bits at the start of a 125 μs frame. The housekeeping bit follows immediately so that all the non-payload data bits are grouped together. Framing circuits in the receiving equipment detect a first framing bit sequence in a first frame and then look for another in the same position in the next frame. Using this technique, a frame will generally be found within a small number of frame periods. Thus the service disruption measurement can be made with a relatively short framing time. Once reception of the test signal is re-established and the framing of the signal is determined, the payload PRBS can be examined for the existence of errors. The receiving equipment interprets the error-free condition as indicating restoration of the incoming data signal, and records the time elapsed since the beginning of the disruption.

At ANSI rates of T1 and T3 (DS1 and DS3) the situation is somewhat different. In this case the framing and housekeeping bits are evenly spaced throughout the payload data. In the case of T1 they are 193 bits apart, and in the case of T3 the framing/housekeeping bits are 85 bits apart. Framing is generally performed by selecting a bit, and a corresponding later bit where one would expect the next framing bit to occur (i.e. 170 or 386 bits later) if the initially selected bit were a framing bit. If the later bit does not match the framing sequence, then the initially selected bit was not a framing bit, so the next bit of the incoming signal is selected and the test is repeated.

The time taken to detect frame alignment with circuits of this nature can be many tens or even hundreds of milliseconds. Only when the framing sequence is detected can payload analysis, and then any service disruption measurement, take place. The order of magnitude of time for operation of a protection switch is a few milliseconds up to a typical maximum of around 50 ms. The framing to allow analysis of the payload must be faster than this in order to allow the above technique for measuring service disruption to be used effectively. But the framing techniques described above can cause the refraining time to exceed the desired measurement resolution by many times, and the re-frame time depends upon random factors so its effect cannot be subtracted from the measurement.

European patent application 0 924 891 describes a technique in which a bit in the transmitted PRBS pattern located eight bit positions ahead of the framing bit is inverted, causing a single bit error. This enables detection of the framing in less than 5 frames. However this method requires a special transmitter pattern and also imposes a permanent error rate on the link, which it would be preferable to avoid.

In principle a massively-parallel frame pattern detection system could be used to locate the frame pattern very rapidly, but this would be at the expense of implementing huge amounts of logic and would be limited to achieving frame synchronisation in two ESF multi-frames, or 3-6 ms.

It is therefore desirable to identify the framing sequence, by identifying the non-payload data elements, more quickly and efficiently and by making use of unperturbed PRBS patterns.

### DISCLOSURE OF INVENTION

According to one aspect of this invention there is provided a method of measuring duration of service disruption affecting communication of a data stream containing payload data and non-payload symbols interspersed within the payload data, comprising the steps of:
receiving a data stream;
detecting commencement of disruption of reception of the data stream;
detecting termination of disruption of reception of the data stream by:
a) monitoring the data stream to detect a symbol having a value indicative of occurrence of an error in the payload data,
b) upon detection of a symbol having a value indicative of occurrence of an error, continuing monitoring for the occurrence of errors in a modified version of the data stream, the modified version of the data stream comprising the received data stream with the detected symbol omitted, and
c) determining that an error has occurred if another symbol having a value indicative of occurrence of an error is detected in the modified version of the data stream after the omitted symbol;
   this monitoring being continued until a predetermined period has elapsed during which there is no determination at step c) that an error has occurred; and
reporting as the duration of service disruption the elapsed time between commencement of disruption of reception and the last determination at step c) of occurrence of an error.

According to another aspect of the invention there is provided apparatus for measuring duration of service disruption affecting communication of a data stream containing payload data and non-payload symbols interspersed within the payload data, comprising:
a receiver for receiving a data stream;
a first detector for detecting commencement of disruption of reception of the data stream;
a second detector for detecting termination of disruption of reception of the data stream by:
a) monitoring the data stream to detect a symbol having a value indicative of occurrence of an error in the payload data,
b) upon detection of a symbol having a value indicative of occurrence of an error, continuing monitoring for the occurrence of errors in a modified version of the data stream, the modified version of the data stream comprising the received data stream with the detected symbol omitted, and
c) determining that an error has occurred if another symbol having a value indicative of occurrence of an error is detected in the modified version of the data stream after the omitted symbol;
   this monitoring being continued until a predetermined period has elapsed during which there is no determination at step c) that an error has occurred; and
an output for reporting as the duration of service disruption the elapsed time between commencement of disruption of reception and the last determination at step c) of occurrence of an error.

### BRIEF DESCRIPTION OF DRAWINGS

A method and apparatus in accordance with this invention, for measuring duration of service disruption affecting communication of a data stream containing payload data and non-payload symbols interspersed within the payload data, will now be described, by way of example, with reference to the accompanying drawings, in which:

FIG. 1 illustrates schematically a test system for testing protection switching in a telecommunication system;

FIG. 2 illustrates schematically a DS1 data stream;

FIG. 3 shows a technique described in European patent application 0 924 891 for detecting framing of a received data signal;

FIG. 4 shows a procedure in accordance with the present invention for determining service disruption time;

FIG. 5 illustrates the effect of insertion in a PRBS data stream of a framing bit;

FIG. 6 illustrates intrinsic uncertainty in the position of a framing bit within a block of like-value data bits;

FIG. 7 illustrates occurrence of a framing bit in different positions within a block of like-valued bits; and

FIG. 8 is a functional block schematic diagram of apparatus for implementing the procedure of FIG. 4.

### DETAILED DESCRIPTION

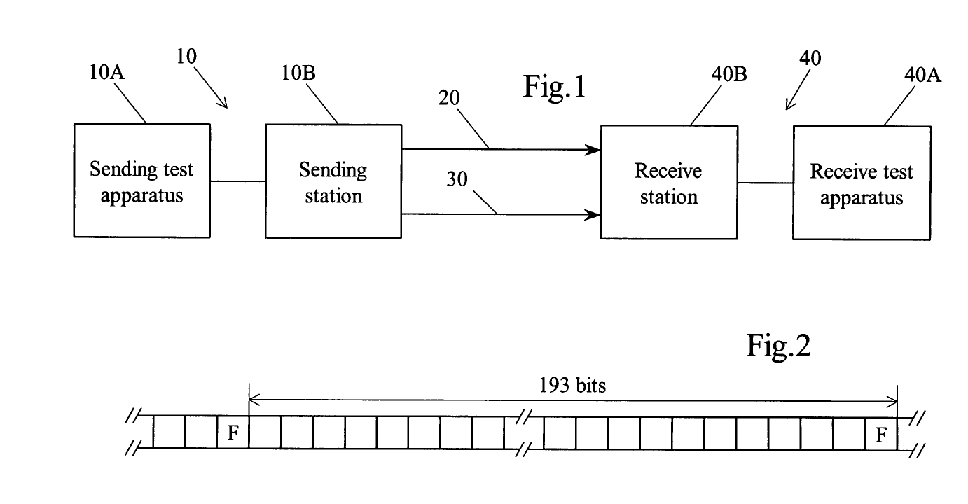

FIG. 1 shows a test system for testing protection switching in a telecommunication system. Referring to FIG. 1, the test system comprises a sending station 10 that includes a sending test apparatus 10A and a sending telecommunications station 10B, a traffic channel 20, a protection channel 30, and a receiving station 40 that includes a receiving test apparatus 40A and a receiving telecommunications station 40B. The sending telecommunications station 10B, traffic channel 20, protection channel 30 and receiving telecommunications station 40B constitute the apparatus being tested. In commercial applications there may be a number of traffic channels and/or a number of protection channels, some of which may correspond to routing through a separate telecommunications station. For simplicity, these variants are not illustrated.

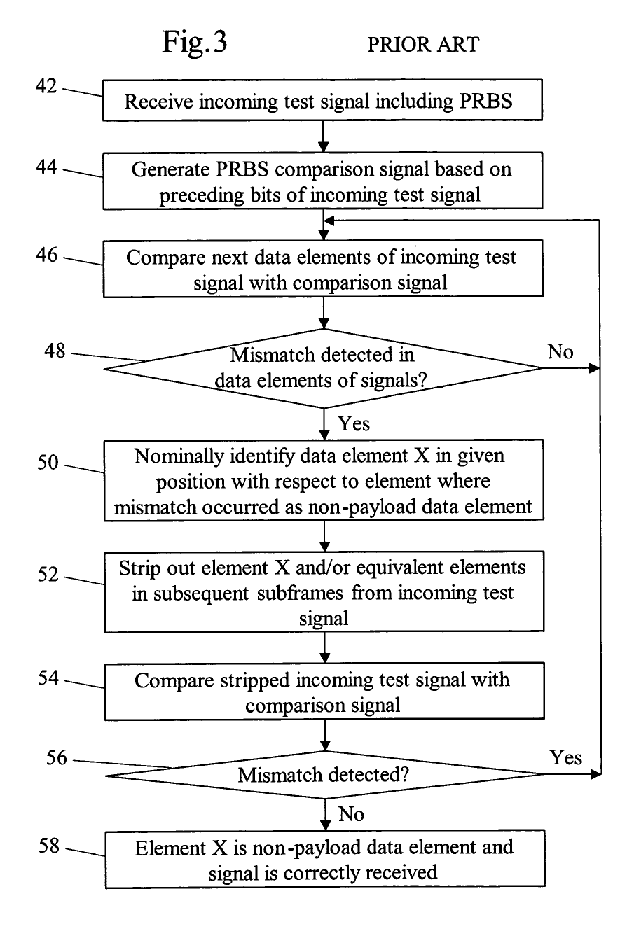

The sending test apparatus 10A generates a test signal, which for example is in the form of a DS1 data stream as illustrated in FIG. 2. The test signal comprises a pseudo-random binary sequence (PRBS) of data symbols (e.g. binary digits or bits) to act as a payload signal and also contains non-payload data. In this example the non-payload data are in the form of framing symbols or bits, designated F in FIG. 2. The signal is divided into subframes by the non-payload data bits, each subframe being 193 bits long and comprising 192 payload data bits and one non-payload (framing) data bit. FIG. 3 illustrates, in simple schematic block diagram form, a method for detecting the framing of such a signal, as described in the above-mentioned European patent application 0 924 891:
42—A PRBS signal generated at the sending station 10 for use as an incoming test signal is received at the receiving station 40.
44—A comparison signal is generated at the receiving station, based on the preceding data elements of the incoming test signal.
46—The signals are compared and
48—if no mismatch is detected the comparison step 46 is repeated for subsequent data elements; however, when a mismatch is detected
50—the apparatus at the receiving station 40 nominally identifies, as a non-payload data element, a data element X in the incoming signal which has a predetermined positional relationship to the data element with which the mismatch was detected.
52—The nominally identified non-payload data element X, and typically equivalently-located elements in subsequent subframes, are stripped out of the incoming signal. Depending on the way that non-data elements are inserted into the PRBS signal, some form of processing other than stripping out may be appropriate: the essence is to process the incoming test signal so that if the nominally identified non-payload data element is indeed a non-payload data element in a clean signal, the processing will reconstitute the PRBS signal from the incoming signal.
54—Then the stripped signal is compared to a comparison signal generated at the receiving station 40.
56—If mismatches are detected then the stripped signal does not correspond to the PRBS of the test signal and it is therefore evident that the nominally identified non-payload data element was not, actually, a non-payload data element (or that the incoming signal is not error-free) in which case it is necessary to search for a further mismatch, that is, to go back to step 46.
58—If no mismatches are found, then it is evident that the stripped signal corresponds to the PRBS of the test signal and that the non-payload data element is correctly identified and the incoming signal correctly framed.

As described in 0 924 891, the relationship between the position of the data element in which the mismatch is identified and the nominally identified non-payload data signal may be simply that they are the same data element. In this case the mismatch occurs because the non-payload data element (that is the framing or overhead element) is not part of the PRBS. The first non-payload data bit in an error free signal has a 50% chance of conforming to the PRBS signal, and a 50% chance of violating the PRBS signal. However (and by way of clarification of the assertion made at the end of paragraph 0019 of 0 924 891) the number of frames required to be sure that frame lock has been achieved is of the order of N to 2N frames, where N is the order of the generating polynomial of the PRBS being used. This is because the technique shown in FIG. 3 takes multiple frames to achieve frame lock, and the value of X (steps 50 and 52) is dependent on the combination of the framing pattern used and the PRBS generator polynomial. As an example, if a DS1 ESF framed signal is used with an order-23 PRBS, then it may take 29 frames (5597 bits or 3.6 ms) to achieve frame lock. In an extreme case, where each framing bit happens to have a pattern that is identical to the payload bits occurring before or after it, frame lock may never be achieved. According to the teaching of 0 924 891 a measurement of disruption time is performed only after frame lock has first been explicitly confirmed to have been achieved. It follows of course that the desired measurement of service disruption cannot be made to the required degree of precision.

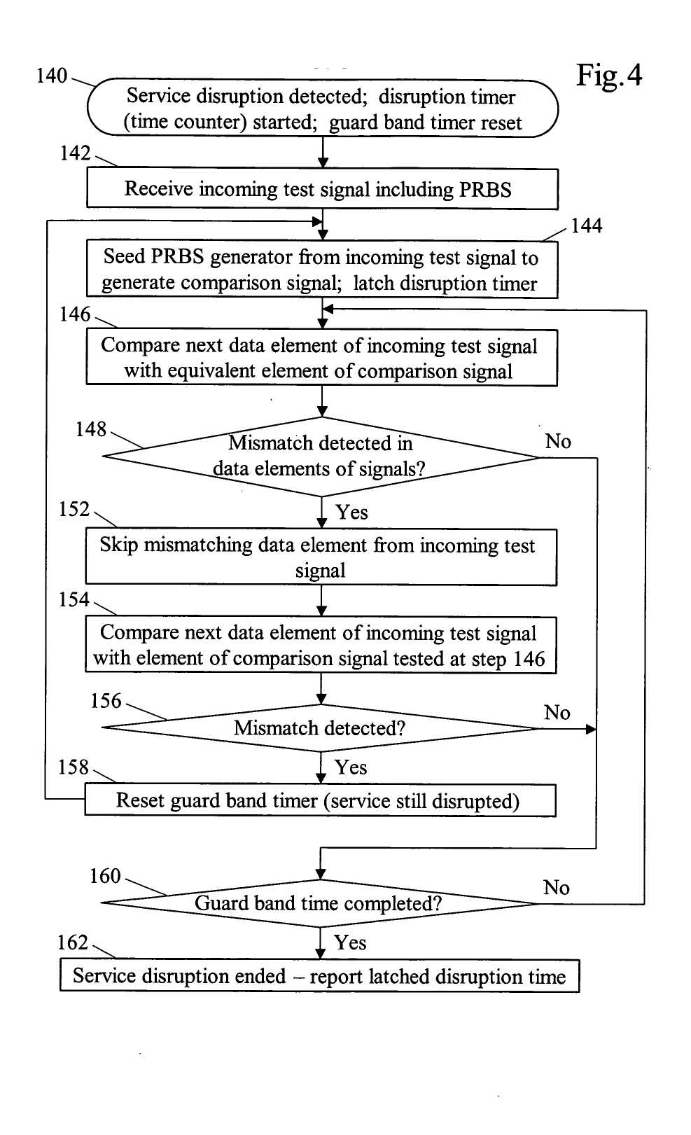

FIG. 4 shows a technique for measuring service disruption, in accordance with the present invention, that avoids the need for the existence of frame lock to be identified, and enables the measurement of service disruption to be accomplished with a precision of a few tens of bits (that is tens of microseconds). In this technique the DS1 framing remains as standard (SF or ESF), and the payload is filled with a standard PRBS pattern (i.e. no special violation of the standard PRBS bit-stream is imposed). Thus any standard PRBS payload test pattern from any source may be used.

Referring to FIG. 4, at the start of the procedure (indicated at 140) it is assumed that the existence of service disruption has been detected in conventional manner and the afore-mentioned time counter (disruption timer) has been started; in addition a timer for the predetermined guard band time (e.g. 200 ms) is reset.

At step 142 the incoming test signal including the PRBS is received, and used at step 144 to seed the local PRBS generator to generate the comparison signal. At the same time the value in the disruption timer is latched as a potential measurement of disruption time. At steps 146 and 148 the next data element (e.g. bit) of the incoming test signal is compared with the equivalent element of the comparison signal, to determine whether they match. If no mismatch is detected the procedure jumps to step 160 where the guard band timer is checked to determine whether the guard band time (e.g. 200 ms) since last detection of a mismatch has elapsed. If not, the procedure returns to step 146 to continue comparison of the next following data elements in the incoming and comparison signals.

If the test at step 148 establishes that there is a mismatch between the data elements, then at step 152 the specific mismatching element of the incoming test signal is skipped, and then a new comparison is performed at step 154 between the next following element of the incoming signal and the element of the comparison signal that was involved in the immediately preceding test at step 148 (and that gave rise to a mismatch). If no mismatch is detected the procedure advances to step 160 as previously described; otherwise the guard band time is reset (because it can be assumed that service disruption is still in progress) and he procedure returns to step 144 to reseed the PRBS generator.

Eventually step 160 will be reached at a point when the guard band time has elapsed, indicating that the service disruption can be taken to have ended. Thereupon the procedure advances to step 162, and reports the last disruption timer value that was latched at step 144 as the required disruption time.

It should be noted that at no specific point in the procedure shown in FIG. 4 is any explicit determination made that frame lock has been achieved. Although as a practical matter such lock must implicitly occur, no step of the procedure relies on its occurrence, and no report is made of such occurrence. As a result a precise determination of service disruption can be made, with an accuracy of the order of tens of microseconds. Effective (though unreported) frame lock can be achieved within 2N+1 bits (note, not frames) for an order-N PRBS generator polynomial, and this time is independent of the framing data pattern. For example, for the aforementioned DS1 ESF framed signal with an order-23 PRBS, the measurement precision is of the order of 47 bits (30 μs), which is the time for implicit lock to be achieved.

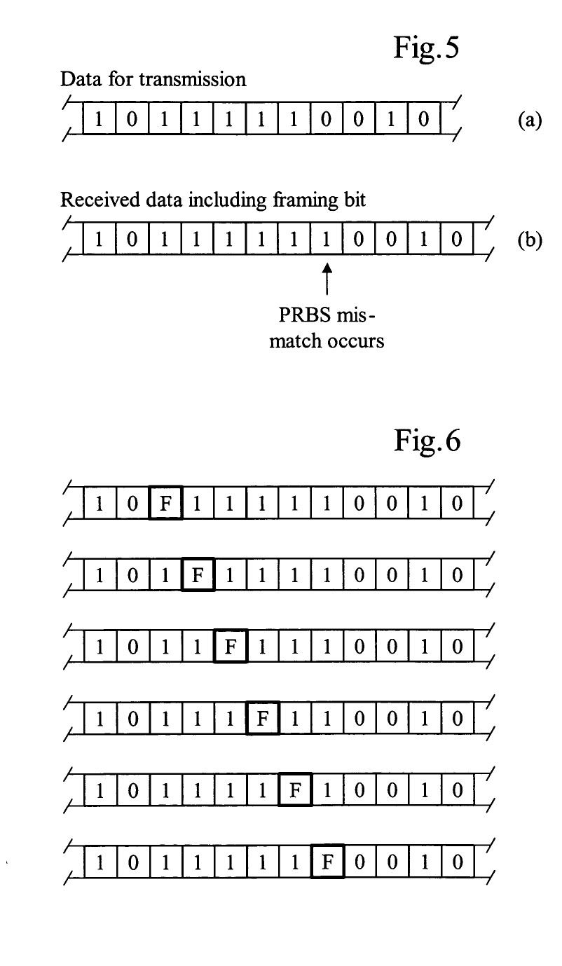

FIGS. 5 to 7 illustrate why the technique described above is assured of correctly detecting the end of mismatch between the incoming test signal and the locally-generated comparison signal without specifically identifying the location of the framing bit and compensating for its presence at that particular position.

Referring to FIG. 5, the upper line labelled (a) shows an example of a sequence of payload data bits as required to be transmitted, and the lower line (b) shows the same sequence with a framing bit having a value of binary 1 inserted somewhere among the third to seventh payload data bits. The procedure described above with reference to FIG. 4 compares the received data in line (b) with a locally-generated version of the data shown in line (a), and at step 148 determines a mismatch has occurred upon comparison of the eighth bit of the received data shown in line (a), at the position arrowed in FIG. 5. However, as shown in FIG. 6, the inserted framing bit responsible may have been added at any one of the six highlighted positions, from before the entire group of third to seventh payload data bits, or anywhere among them, to after that group. The resulting received data stream is the same in each case. Thus the bit position at which the mismatch occurs is not necessarily the location of the framing bit itself.

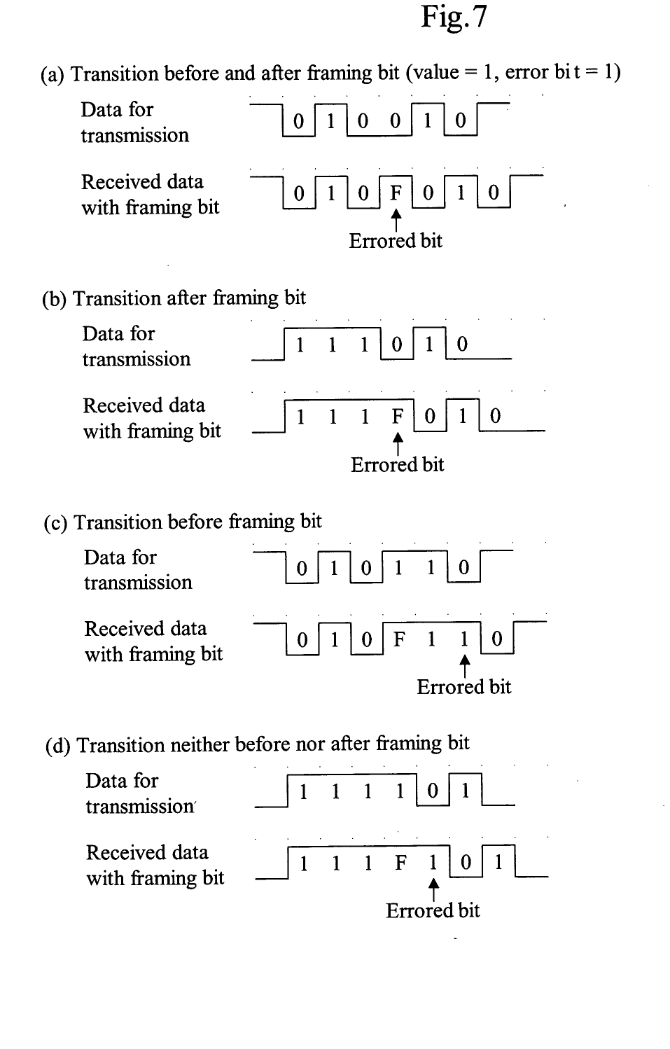

However, it can be stated with confidence that the value of the bit at which the mismatch is detected is same as the value of the framing bit that is proximate to that mismatching bit. This can be seen by inspection of FIG. 7, which shows the relationship between the framing bit and the bit causing mismatch for each of the four possible combinations of framing bit and adjacent bit values: (a) both adjacent bits differ in value from the framing bit; (b) only the trailing bit differs from the framing bit; (c) only the preceding bit differs from the framing bit; or (d) both adjacent bits are the same value as the framing bit. In each case it can be seen that, although the locations of the framing bit and the mismatching bit have no fixed relationship, the values of these bits are always the same.

Rather than detecting the framing sequence, the invention detects the presence of framing bits (by virtue of the mismatch they cause with the comparison PRBS) and discards them. The framing bits are not checked to determine the frame alignment, but instead they are merely removed from causing both a mismatch and a phase delay in the received PRBS pattern relative to the comparison PRBS. Because each mismatched bit has the same binary value as the proximate framing bit, as demonstrated above, discarding of the framing bits can be accomplished by discarding the mismatched bits whether or not they actually coincide in position with the framing bits themselves.

If a discarded mismatching bit is in fact a genuine errored bit (with no framing bit nearby), its removal will cause a phase misalignment between the received and comparison PRBSs. That will in turn cause further mismatches in the comparison of the misaligned bits, so the error will be (indirectly) detected, indicating that service disruption is continuing. However if the mismatch that resulted in discarding of a bit is caused by the presence of a framing bit, then discarding that bit maintains synchronisation between the received and comparison PRBSs, enabling the end of service disruption to be promptly detected when it occurs.

Although the invention has for convenience been described by reference to an example involving the use of binary digits, it is also applicable to systems involving the use of multiple-valued data symbols, such as ternary, quaternary or higher-order systems. Likewise the example described is based on the use of a PRBS pattern, but the invention is equally applicable to use with any data payload pattern that can be predicted at the receiver so that error-detection can be performed. An example of an alternative data payload would be a repeating, fixed-length sequence of symbols (which may even be user-defined). A block of the most recently received incoming data symbols, of the same length as the repeating payload pattern, is compared with all possible cyclic permutations of the payload pattern, in order to determine whether an error has occurred. If no comparison yields a match, implying either that an error has occurred or a framing symbol has been inserted, the last received symbol in the block of incoming data symbols is discarded, and replaced with the next received symbol, and the comparison with the cyclic permutations of the payload pattern is repeated.

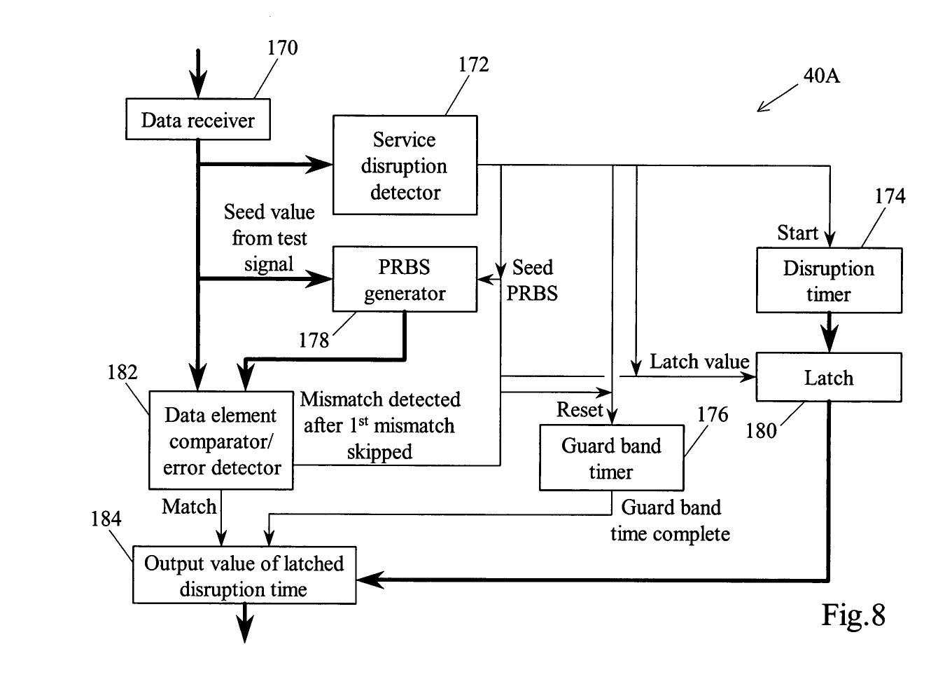

FIG. 8 is a block diagram showing schematically how the receiving test apparatus 40A may be functionally configured to implement the procedure described above with reference to FIG. 4. Referring to FIG. 8, the apparatus 40A includes a data receiver 170, and a service disruption detector 172 that detects service disruption in known manner (step 140 of FIG. 4) and thereupon starts a disruption timer 174 and resets a guard band timer 176; the detector 172 also triggers a PRBS generator 178 for a first time to seed a PRBS from the test signal coupled via the data receiver 170, and latches the value in the disruption timer 174 into a latch 180 (step 144). The incoming test signal and the comparison PRBS are compared in a comparator 182, which either generates a “match” output, or, in the event of a mismatch, skips the mismatching data element in the incoming test signal and repeats the comparison as described above (steps 148 to 154). If a further mismatch is detected (step 156) the comparator 182 resets the guard band timer 176 (step 158) and returns to step 144 of the procedure, triggering the PRBS generator 178 to reseed the PRBS and latching the current disruption time into the latch 180, and then repeats the comparison steps. When a match is detected by the comparator 182, a signal indicative of this is supplied to an output circuit 184; when this circuit also receives a signal from the guard band timer 176 indicating that the guard band time has been completed, it supplies an output indicating that the service disruption has ended and giving the duration of the (latched) disruption time.

1. A method of measuring duration of service disruption affecting communication of a data stream containing payload data and non-payload symbols interspersed within the payload data, comprising the steps of:
receiving a data stream;
detecting commencement of disruption of reception of the data stream;
detecting termination of disruption of reception of the data stream by:
a) monitoring the data stream to detect a symbol having a value indicative of occurrence of an error in the payload data,
b) upon detection of a symbol having a value indicative of occurrence of an error, continuing monitoring for the occurrence of errors in a modified version of the data stream, the modified version of the data stream comprising the received data stream with the detected symbol omitted, and
c) determining that an error has occurred if another symbol having a value indicative of occurrence of an error is detected in the modified version of the data stream after the omitted symbol;
this monitoring being continued until a predetermined period has elapsed during which there is no determination at step c) that an error has occurred; and
reporting as the duration of service disruption the elapsed time between commencement of disruption of reception and the last determination at step c) of occurrence of an error.

2. The method of claim 1, wherein the payload data comprises a pseudo-random binary sequence, and monitoring to detect a symbol having a value indicative of occurrence of an error in the payload data is performed by comparing the content of the data stream with the content of an expected pseudo-random binary sequence.

3. The method of claim 1, wherein the payload data comprises a predetermined group of data symbols, and monitoring to detect a symbol having a value indicative of occurrence of an error in the payload data is performed by comparing the content of a block of symbols in the data stream having the same length as said group with cyclic permutations of the predetermined group of data symbols.

4. Apparatus for measuring duration of service disruption affecting communication of a data stream containing payload data and non-payload symbols interspersed within the payload data, comprising:
a receiver for receiving a data stream;
a first detector for detecting commencement of disruption of reception of the data stream;
a second detector for detecting termination of disruption of reception of the data stream by:
a) monitoring the data stream to detect a symbol having a value indicative of occurrence of an error in the payload data,
b) upon detection of a symbol having a value indicative of occurrence of an error, continuing monitoring for the occurrence of errors in a modified version of the data stream, the modified version of the data stream comprising the received data stream with the detected symbol omitted, and
c) determining that an error has occurred if another symbol having a value indicative of occurrence of an error is detected in the modified version of the data stream after the omitted symbol;
this monitoring being continued until a predetermined period has elapsed during which there is no determination at step c) that an error has occurred; and
an output for reporting as the duration of service disruption the elapsed time between commencement of disruption of reception and the last determination at step c) of occurrence of an error.
